(19) United States
(12) Patent Application Publication
(10) Pub. No.: US 2009/0160710 A1
(43) Pub. Date: Jun. 25, 2009

(54) Method and apparatus for estimating location to support location based service of terminal in mobile communication system

(75) Inventors: Suk-Seung Hwang, Yongin-si (KR); Joo-Hyun Lee, Suwon-si (KR); Sang-Boh Yun, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/317,224

(22) Filed: Dec. 19, 2008

(30) Foreign Application Priority Data
Dec. 20, 2007 (KR) 10-2007-0133997

(51) Int. Cl. G01S 1/24

(52) U.S. Cl. 342/387

(57) ABSTRACT

A method and an apparatus for estimating a location to support a location based service of a terminal in a mobile communication system are provided. The method includes receiving first reference signals from three base stations, calculating TDOAs, and solving a first equation using the TDOAs based on the first reference signals; when a solution of determining a location of a terminal based on the first equation is real or imaginary values, receiving second reference signals from the three base stations, calculating TDOAs, and solving a second equation using the TDOAs based on the second reference signals; and when a solution of determining the location of the terminal based on the second equation is real or imaginary values, determining the location of the terminal based on a relation between the first equation and the second equation.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Dec. 20, 2007 and assigned Serial No. 10-2007-0133997, the entire disclosure of which is hereby incorporated by reference.

### TECHNICAL FIELD OF THE INVENTION

The present invention relates to a location based service of a terminal in a mobile communication system. More particularly, the present invention relates to a method and an apparatus for reducing a measurement error when estimating a location of a user using a Time Difference Of Arrival (TDOA).

### BACKGROUND OF THE INVENTION

A Location Detection Technology (LDT) for a Location-Based Service (LBS) includes a cell IDentifier (ID), an Angle Of Arrival (AOA), a Time Of Arrival (TOA), a Time Difference Of Arrival (TDOA), a Global Positioning System (GPS), an Assisted GPS (A-GPS), and so forth. The GPS and the A-GPS are most prevalently used for LDT due to their excellent accuracy. However, since at least four GPS satellites are required, a hybrid GPS using the TDOA or the cell ID is applied in a shadow region not supporting the four satellites. The hybrid GPS determines available techniques except for the GPS according to the desired service requirement or the number of base stations for a user.

In the location estimation of the user, the TDOA of the LDT is mostly used in the absence of a GPS receiver or in the GPS shadow region in the hybrid GPS. To estimate the location using the TDOA, signals should be received from three or more base stations. Unlike the TOA which requires synchronization between the base station and the terminal, the TDOA needs the synchronization merely between the base stations and thus has the preference among the non-GPS LDT schemes. The TDOA acquires two or more hyperbolas from the received signals and estimates the location of the user using an intersection point of the hyperbolas. Mathematical expressions for the location form a set of nonlinear equations. Those complicated expressions are algebraically arranged by Fang or Chan. The methods suggested by Fang or Chan acquire the intersection point by solving a quadratic equation. In so doing, a double value, two real values, or two imaginary values can be produced. The double value enables accurate estimation of the location of the terminal, whereas the two real values leave ambiguity regarding the location estimation solution and the two imaginary values disallow the location estimation per se.

### SUMMARY OF THE INVENTION

To address the above-discussed deficiencies of the prior art, it is a primary aspect of the present invention to address at least the above mentioned problems and/or disadvantages and to provide at least the advantages described below. Accordingly, an aspect of the present invention is to provide a method and an apparatus for reducing a location estimation error caused when there is a plurality of intersection points or no intersection of two curves to estimate a location of a user using a Time Difference Of Arrival (TDOA) in a mobile communication system.

The above aspects are achieved by providing a method for estimating a location to support a location based service of a terminal in a mobile communication system. The method includes receiving first reference signals from three base stations, calculating TDOAs, and solving a first equation using the TDOAs based on the first reference signals; when a solution of determining a location of a terminal based on the first equation is real or imaginary values, receiving second reference signals from the three base stations, calculating TDOAs, and solving a second equation using the TDOAs based on the second reference signals; and when a solution of determining the location of the terminal based on the second equation is real or imaginary values, determining the location of the terminal based on a relation between the first equation and the second equation.

According to one aspect of the present invention, an apparatus for estimating a location to support a location based service of a terminal in a mobile communication system, includes a value determiner for receiving first reference signals from three base stations, calculating TDOAs, solving a first equation using the TDOAs based on the first reference signals, when a solution of determining a location of a terminal based on the first equation is real or imaginary values, receiving second reference signals from the three base stations, calculating TDOAs, and solving a second equation using the TDOAs based on the second reference signals; and a location determiner for, when a solution of determining the location of the terminal based on the second equation is real or imaginary values, determining the location of the terminal based on a relation between the first equation and the second equation.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a frame structure for a Location Detection Technology (LDT) using an enhanced Time Difference Of Arrival (TDOA) according to an exemplary embodiment of the present invention;

FIG. 2 illustrates a location estimation method for supporting a location based service of a terminal in a mobile communication system according to an exemplary embodiment of the present invention;

FIG. 3A illustrates the location estimation of the terminal when a new solution is two real values and a previous solution is two real values according to an exemplary embodiment of the present invention;

FIG. 3B illustrates the location estimation of the terminal when a new solution is two real values and a previous solution is two imaginary values according to an exemplary embodiment of the present invention;

FIG. 4A illustrates the location estimation of the terminal when imaginary values are produced from previous two TDOAs, a solution of intersection of two new TDOAs is two real values, and there are no intersection points between the previous two TDOAs and the two new TDOAs;

FIG. 4B illustrates the location estimation of the terminal when imaginary values are produced from previous two TDOAs, a solution of intersection of two new TDOAs is two real values, and there are intersection points between the previous two TDOAs and the two new TDOAs;

FIG. 4C illustrates the location estimation of the terminal when imaginary values are produced from previous two TDOAs, a solution of intersection points of two new TDOAs is two imaginary values, and there are intersection points between the previous TDOAs and the new TDOAs; and

FIG. 5 illustrates a location estimation apparatus for supporting the location based service of the terminal in the mobile communication system according to an exemplary embodiment of the present invention.

Throughout the drawings, like reference numerals will be understood to refer to like parts, components and structures.

### DETAILED DESCRIPTION OF THE INVENTION

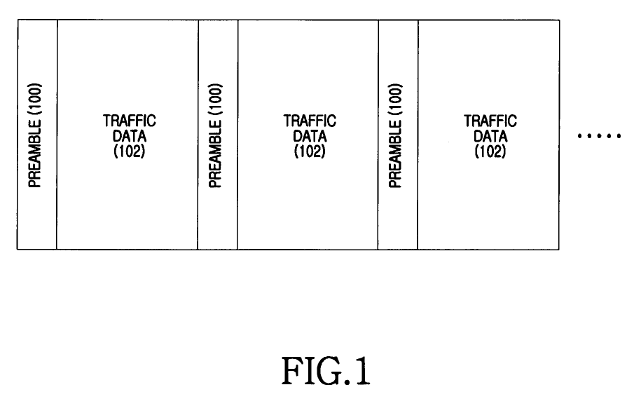

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communication system.

Exemplary embodiments of the present invention provide a method and an apparatus for estimating a location to support a location based service of a terminal in a mobile communication system.

FIG. 1 illustrates a frame structure for a Location Detection Technology (LDT) using an enhanced Time Difference Of Arrival (TDOA) according to an exemplary embodiment of the present invention.

The present invention considers the frame structure which periodically carries a preamble 100 or a pilot signal (not shown) and allocates and carries traffic data 102 after the preamble 100. The pilot signal forms a bin or tile structure with the traffic data 102 in a preset pattern. Hereafter, the preamble 102 or the pilot signal is referred to as a reference signal.

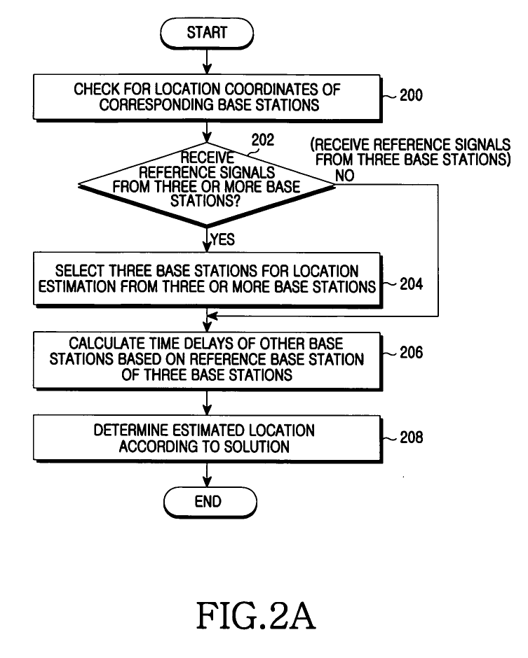

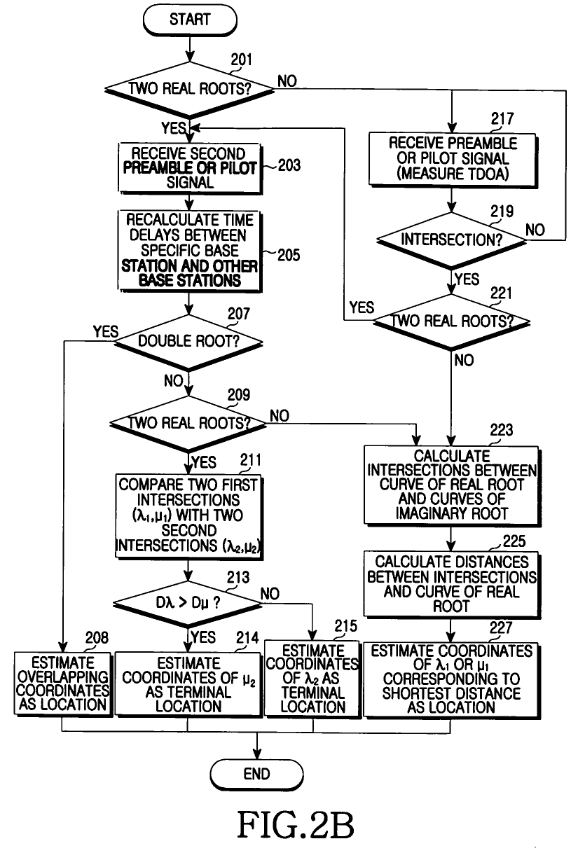

FIG. 2A is a flowchart illustrating a location estimation method for supporting a location based service of a terminal in a mobile communication system according to an exemplary embodiment of the present invention.

In step 200, the terminal checks for the location coordinates of corresponding neighbor base stations including a serving base station. The location coordinates of each base station is preset and known to the terminal in advance. Alternatively, the terminal can receive the coordinates from each base station.

When receiving first reference signals from three or more base stations in step 202, the terminal selects three base stations for the location measurement from the three or more base station on a certain basis in step 204. For example, when groups of base stations are connected, the terminal can select the base stations of the same group.

When not receiving the first reference signals from three or more base stations in step 202 (that is, when receiving the reference signals from three base stations), the terminal goes to step 206. Herein, it is assumed that the terminal receives the reference signals from three or more base stations.

Herein, the first reference signal indicates a signal initially received for the location estimation of the terminal.

In step 206, the terminal calculates TDOAs between a specific one of the three base stations and the other base stations. The TDOA can be calculated from a correlation of the preambles or the pilot signals periodically received from the three or more base station. For example, given three base stations, the TDOA is calculated from the correlation between the first base station R1 and the neighbor base station R2 and the TDOA calculated from the correlation between the first base station R1 and the neighbor base station R3.

In step 208, the terminal acquires two or more hyperbolas to calculate a value (x, y) for the terminal location estimation using the coordinates of the base stations and the TDOAs and then determines a location estimation value based on the value. The hyperbolas are given by Equation 1:

$${R}_{i , 1} = {cd}_{i , 1} = {R}_{i} - {R}_{1} = \sqrt{{( {X}_{i} - x )}^{2} + {( {Y}_{i} - y )}^{2}} - \sqrt{{( {X}_{1} - x )}^{2} + {( {Y}_{1} - y )}^{2}} . \qquad [ Eqn . 1 ]$$

In Equation 1, R_{i,1} denotes a distance difference between a reference base station (e.g., the serving base station) and the i-th base station, c denotes a propagation velocity, d_{i,1} denotes a TDOA between the reference base station and the i-th base station, Rᵢ denotes a distance between the i-th base station and the terminal, R₁ denotes a distance between the reference base station and the terminal, (Xᵢ,Yᵢ) denotes coordinates of the i-th base station, and (x, y) denotes coordinates of the terminal to locate.

Finally, the location (x,y) of the user terminal can be obtained from an intersection point of two or more hyperbolas. Since Equation 1 is the nonlinear quadratic equation, it is quite hard to acquire its solution. This nonlinear problem can be linearized using Taylor series. Yet, the Taylor series may cause a considerable location estimation error in the linearization. To reduce the linearization error, the expression algebraically arranged by Fang or the expression arranged by Chan is mostly used for the TDOA location estimation. The expression of Fang or Chan solves the quadratic equation. The acquired solution is a double value, two real values, or two imaginary values. The single double value leads to accurate location estimation. That is, the double value (x,y) is the location coordinates of the terminal. By contrast, the two real values leave ambiguity because of the two values and the two imaginary values disallow location estimation per se. To address those drawbacks, the present invention performs a process according to the acquired solution, to be explained in reference to FIG. 2B.

Alternatively, three of the three or more base stations are selected and the location is not estimated with the hyperbolas based on Equation 1, but hyperbolas are generated for the location estimation of Equation 1 in every possible case which groups the three selected base stations out of the three more base stations. For example, given four base stations, the number of groups including three base stations is 24. Accordingly, 24 hyperbolas are generated in total. The location can be estimated from the hyperbola which produces the double value. Detecting no double value, the location is estimated through an additional process of FIG. 2B.

FIG. 2B is a flowchart illustrating the location estimation method according to the solution of the location coordinates of the terminal as acquired in FIG. 2A.

When the solution for the location estimation acquired from the two measured TDOAs is the double value, there is a single intersection point of the curves of the two TDOAs and the coordinates of the intersection can be estimated as the location of the user terminal (not shown).

Referring now to FIG. 2B, when the solution calculated for the location estimation using the two measured TDOAs is two real values in step 201, the terminal receives a second reference signal in step 203. The second reference signal is a signal received after the first reference signal. In step 205, the terminal calculates TDOAs of the specific base station and the other base stations using the second reference signal.

More specifically, when the solution calculated for the location estimation is two real values, there are two intersections of the two TDOAs and ambiguity remains in the location estimation. To remove the ambiguity, the location estimation process is suspended until the next second reference signal is received and stands by until two new TDOAs are acquired with the next second reference signal.

When the value (x,y) for the terminal location estimation using the TDOAs of the second reference signal is the double value in step 207, the terminal determines the double value as the terminal location estimation value in step 208.

When the solution is not the double value in step 207, the terminal checks whether the new solution is two real values in step 209. For the two real values, the terminal compares the two new real values with the two previous real values in step 211. The terminal selects a case where the distance between the corresponding intersections is shorter in step 213 and estimates a new intersection of the selected intersections as the user's location in steps 214 and 215.

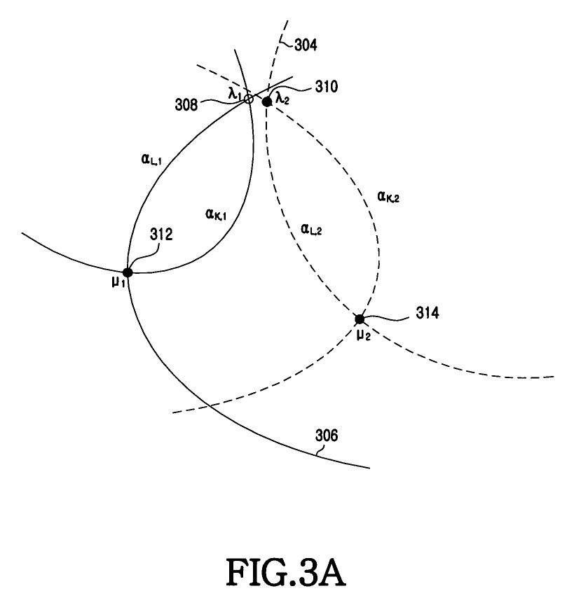

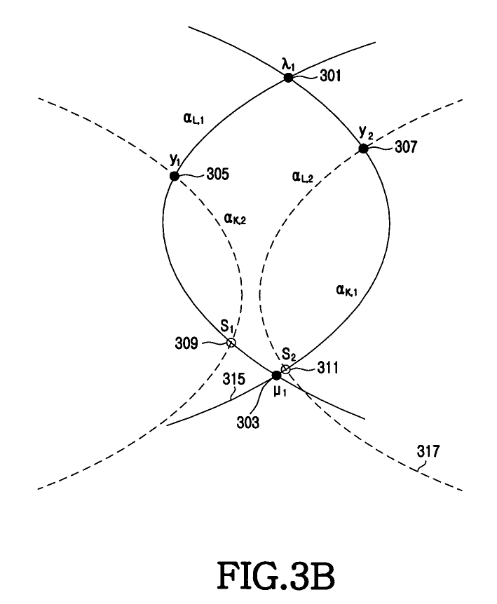

FIG. 3A illustrates the location estimation of the terminal when a new solution is two real values and a previous solution is two real values according to an exemplary embodiment of the present invention.

For instance, initially, a curve α_{l,1} 306 for the first base station and the l-th base station, a curve α_{k,1} 306 for the first base station and the k-th base station, a curve α_{l,2} 304 for the second base station and the l-th base station acquired from the preamble or the pilot signal of the next frame, and a curve α_{k,2} 304 for the second base station and the k-th base station are depicted. Let intersections of α_{l,1} and α_{k,1} be λ₁ 308 and μ₁ 312 and let intersections of α_{l,2} and α_{k,2} be λ₂ 310 and μ₂ 314. After d_{λ}=|λ₁−λ₂| and d_{μ}=|μ₁−μ₂| are calculated, when d_{λ}>d_{μ}, the coordinates of μ₂ are estimated as the location of the terminal. When d_{λ}<d_{μ} the coordinates of λ₂ are estimated as the location of the terminal. The location of the terminal is set to the coordinates of λ₂ in FIG. 3A. That is, the location of the terminal based on the first reference signal is one of λ₁ 308 and μ₁ 312. The location of the terminal based on the second reference signal is one of λ₂ 310 and μ₂ 314. The shorter distance between λ₁ 308 and λ₂ 310 implies that either λ₁ 308 or λ₂ 310 is highly likely to be the location coordinates of the terminal. In various implementations, instead of λ₂ 310, λ₁ 308 can be estimated as the location of the terminal.

When the new solution is the imaginary values in step 209, the terminal calculates intersections between the curve of the real values (the previous curve) and the curves of the imaginary values (the new curves) in step 223. In step 225, the terminal computes distances between the intersections and the curve of the real value. In step 227, the terminal estimates the coordinates of λ₁ or μ₁ having the shorter distance as the location of the terminal.

FIG. 3B illustrates the location estimation of the terminal when a new solution is two real values and a previous solution is two imaginary values according to an exemplary embodiment of the present invention.

Intersections of α_{l,1} and α_{k,2}, and intersections y₁ 305, y₂ 307, s₁ 309, and s₂ 311 of a curve α_{l,2} 317 and a curve α_{k,1} 315 are detected. The maximum number of the intersections is four. In this embodiment of the present invention, four intersections are illustrated. Provided that two intersections corresponding to λ₁ 301 are y₁ 305, which is one of two intersections of α_{l,1} and α_{k,2}, and y₂ 307, which is one of two intersections of α_{l,2} and α_{k,1}, and two intersections corresponding to μ₁ 303 are s₁ 309, which is one of two intersections of α_{l,1} and α_{k,2}, and s₂ 311, which is one of two intersections of α_{l,2} and α_{k,1}, their distances are given by d_{y1}=|λ₁−y₁|, d_{y2}=|λ₁−y₂|, dₛ₁=|μ₁−s₁|, and dₛ₂=|μ₁−s₂|. The shortest one of the distances is detected, and the corresponding coordinates of λ₁ 301 or μ₁ 303 are estimated as the coordinates of the user.

Among the intersections y₁ 305, y₂ 307, s₁ 309, and s₂ 311, λ₁ 301, and μ₁ 303, s₁ 309, s₂ 311, and μ₁ 303 are close to each other. Hence, it is highly likely that the location of the terminal will be one of s₁ 309, s₂ 311, and μ₁ 303. Herein, the intersection μ₁ 303 of the hyperbola is determined as the location of the terminal.

When there are no intersections between the two initial curves and the later curves, steps 201 through 215 or steps 223 through 227 are repeated using TDOAs acquired from the third reference signal of the next frame. That is, those steps are repeated until two curves having intersections with the two initial curves are detected. In fact, such a case is rare. Using two sample reference signals, the accurate location of the terminal can be estimated.

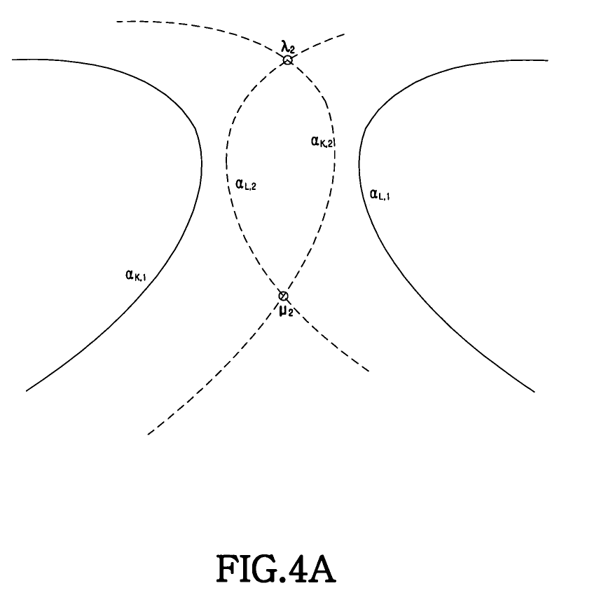

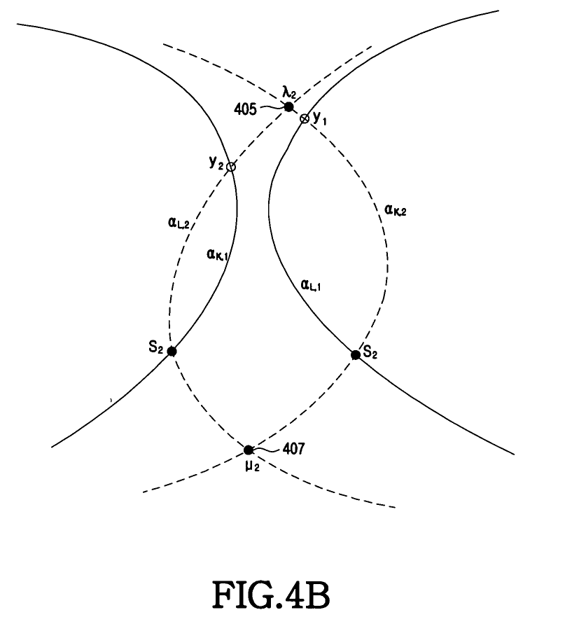

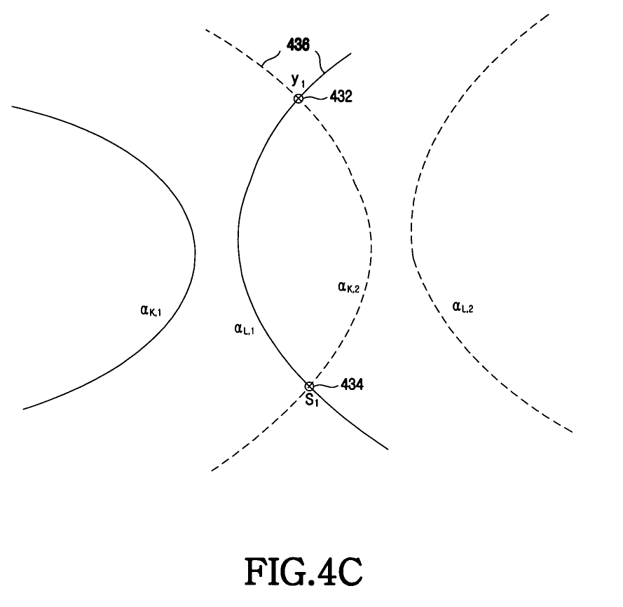

When the solution for the location estimation calculated using the two measured TDOAs are not two real values (that is, when the solution is two imaginary values in step 201), the terminal measures TDOAs using a next reference signal in step 217. The terminal repeats step 217 until hyperbolas of the measured TDOAs have intersections or intersections of a new curve is detected in step 219. Namely, the location estimation of the user is infeasible when there are no intersections for two hyperbolic equations. The TDOA measurement continues using the reference signal until two TDOA curves having two intersections are detected for the TDOAs calculated in step 217 (see FIG. 4A or 4B) or until intersections are found between the initial TDOA curve and the new TDOA curve (see FIG. 4B or 4C). Herein, when a double value is produced in the new TDOA curve, the new value becomes the location estimation coordinates of the terminal (not shown).

When two real values are produced from two new TDOA curves and intersections are not found in step 221, the terminal performs steps 203 through 215. By contrast, when two real values are not produced from two new TDOA curves and intersections are detected, the terminal performs steps 223 through 227.

Herein, methods in various cases of FIGS. 4A, 4B and 4C can be summarized as follows.

When imaginary values are obtained from two previous TDOAs and a solution of an intersection of two new TDOAs is a double value, the new solution becomes the estimated location of the terminal (not shown).

When imaginary values are obtained from two previous TDOAs, a solution of the intersection of two new TDOAs is two real values, and there are no intersections between the two previous TDOAs and the two new TDOAs (see FIG. 4A), the two previous TDOAs are disregarded and the location of the terminal is estimated using the two new TDOAs as the reference time point in steps 203 through 215.

When imaginary values are produced from two previous TDOAs, a solution of the intersection of two new TDOAs is two real values, and the two previous TDOAs and the two new TDOAs have intersections (see FIG. 4B), the terminal performs steps 223 through 227, similar to FIG. 3B. For example, after calculating distances of d_{y1}=|λ₂−y₁|, d_{y2}=|λ₂−y₂|, dₛ₁=|μ₂−s₁|, and dₛ₂=|μ₂−s₂|, the coordinates of λ₂ 405 or μ₂ 407 corresponding to the shortest distance are estimated as the coordinates of the user.

When imaginary values are produced from two previous TDOAs, a solution of the intersection of two new TDOAs is two imaginary values, and the previous TDOAs and the new TDOAs have intersections (see FIG. 4C), the terminal performs steps 211 through 215 using the curve 436 including y₁ 432 and s₁ 434 and the new curve generated in steps 203 and 205, which is not depicted in FIG. 2B.

Next, the terminal finishes this process.

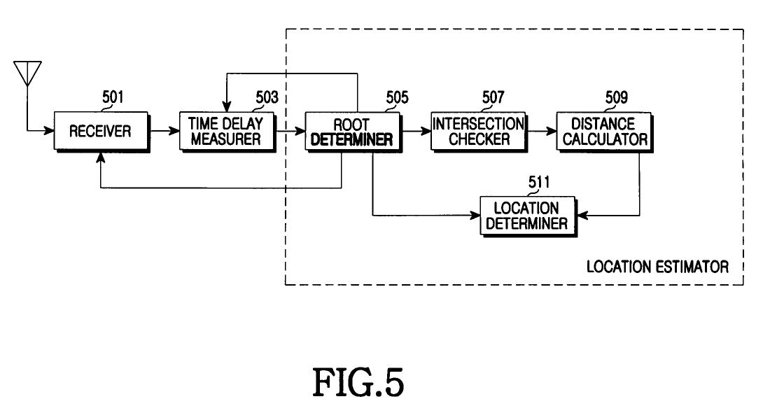

FIG. 5 is a block diagram of a location estimation apparatus for supporting the location based service of the terminal in the mobile communication system according to an exemplary embodiment of the present invention.

A receiver 501 receives reference signals from three or more base stations. A time delay measurer 503 calculates TDOAs of other base stations based on a specific base station using the reference signals. A value determiner 505 calculates a solution of the terminal location coordinates from a first relational expression of the TDOAs and the coordinates of the base stations. A location determiner 511 estimates coordinates of the terminal location based on the solution.

For instance, when the solution is the double value, the estimated location of the terminal is the double value. When the solution is two real values, the receiver 501 receives second reference signals from three or more base stations and the time delay measurer 503 calculates TDOAs of other base stations based on a specific base station using the second reference signals. When the solution of the intersection of the two new TDOAs is two real values, a distance calculator 509 compares distances of the two initial real values and the two new real values, selects the shorter distance between two values, and estimates the selected value as the location of the terminal (see FIG. 3A). When the solution is two real values, the preamble or the pilot signal of the next frame is received and TDOA is calculated. Next, when the solution of the intersection of two new TDOAs is two imaginary values, an intersection checker 507 calculates intersections between the curve of the real values (the previous curve) and the curves of the imaginary values (the new curves). The distance calculator 509 computes a distance between the intersections and the curve of the real value. The location determiner 511 estimates the coordinates corresponding to the shortest distance as the terminal location (see FIG. 3B).

When the initial solution is two imaginary values and two curve equations do not have intersections, the location estimation of the user is infeasible. Thus, the TDOA measurement continues using the preamble or the pilot signal until two TDOA curves having two intersections for new TDOAs are detected (see FIG. 4A or 4B) or until intersections are found between the initial TDOA curve and the new TDOA curve (see FIG. 4B or 4C).

As set forth above, in the location estimation of the user using the TDOA in the mobile communication system, the double value, the two real values, and the two imaginary values are considered. Therefore, the ambiguity of the location estimation can be removed in case of the two real values and the location estimation can be accomplished in the case of the two imaginary values.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for estimating a location of a terminal to support a location based service in a mobile communication system, the method comprising:
receiving first reference signals from three base stations, calculating Time Difference Of Arrivals (TDOAs), and solving a first equation using the Time Difference Of Arrivals based on the first reference signals;
when a solution of determining a location of a terminal based on the first equation is real or imaginary values, receiving second reference signals from the three base stations, calculating Time Difference Of Arrivals, and solving a second equation using the Time Difference Of Arrivals based on the second reference signals; and
when a solution of determining the location of the terminal based on the second equation is real or imaginary values, determining the location of the terminal based on a relation between the first equation and the second equation.

2. The method of claim 1, wherein determining the location of the terminal based on the relation between the first equation and the second equation comprises:
when the solutions of the first equation and the second equation are real values, selecting one of the solutions having a shortest distances between the solutions and determining the selected solution as the location of the terminal.

3. The method of claim 1, wherein determining the location of the terminal based on the relation between the first equation and the second equation comprises:
determining a solution of the first equation closest to intersections as the location of the terminal using the intersections of the first equation and the second equation when the solution of the first equation is real values and the solution of the second equation is imaginary values or when the solution of the first equation is imaginary values and the solution of the second equation is real values.

4. The method of claim 3, further comprising:
when there are no intersections, receiving third reference signals from the three base stations, calculating Time Difference Of Arrivals, and solving a third equation using the Time Difference Of Arrivals based on the third reference signals; and
when a solution of determining the location of the terminal based on the third equation is real or imaginary values, determining the location of the terminal based on a relation between the second equation and the third equation.

5. The method of claim 4, wherein determining the location of the terminal based on the relation between the second equation and the third equation comprises:
when solutions of the second equation and the third equation are real values, selecting one of solutions having a shortest distance between the solutions and determining the selected solution as the location of the terminal.

6. The method of claim 4, wherein determining the location of the terminal based on the relation between the second equation and the third equation comprises:
when the solution of the second equation is real values and the solution of the third equation is imaginary values or when the solution of the second equation is imaginary values and the solution of the third equation is real values, determining the solution of the second equation closest to intersections as the location of the terminal using the intersections of the second equation and the third equation.

7. The method of claim 1, wherein determining the location of the terminal based on the relation between the first equation and the second equation comprises:
when the solutions of the first equation and the second equation are imaginary values, determining the location of the terminal based on a relation between intersections of the first equation and the second equation and the third equation acquired using the Time Difference Of Arrivals according to the third reference signals.

8. An apparatus for estimating a location to support a location based service of a terminal in a mobile communication system, the apparatus comprising:
a value determiner for receiving first reference signals from three base stations, calculating Time Difference Of Arrivals (TDOAs), solving a first equation using the Time Difference Of Arrivals based on the first reference signals, when a solution of determining a location of a terminal based on the first equation is real or imaginary values, receiving second reference signals from the three base stations, calculating Time Difference Of Arrivals, and solving a second equation using the Time Difference Of Arrivals based on the second reference signals; and
a location determiner for, when a solution of determining the location of the terminal based on the second equation is real or imaginary values, determining the location of the terminal based on a relation between the first equation and the second equation.

9. The apparatus of claim 8, wherein the location determiner, when the solutions of the first equation and the second equation are real values, selects one of solutions having shortest distances between the solutions and determines the selected solution as the location of the terminal.

10. The apparatus of claim 8, wherein the location determiner determines the solution of the first equation closest to intersections as the location of the terminal using the intersections of the first equation and the second equation when the solution of the first equation is real values and the solution of the second equation is imaginary values or when the solution of the first equation is imaginary values and the solution of the second equation is real values.

11. The apparatus of claim 8, wherein the value determiner, when there are no intersections, receives third reference signals from the three base stations, calculates Time Difference Of Arrivals and solves a third equation using the Time Difference Of Arrivals based on the third reference signals, and
the location determiner, when a solution of determining the location of the terminal based on the third equation is real or imaginary values, determines the location of the terminal based on a relation between the second equation and the third equation.

12. The apparatus of claim 11, wherein the location determiner, when solutions of the second equation and the third equation are real values, selects one of solutions having a shortest distance between the solutions and determines the selected solution as the location of the terminal.

13. The apparatus of claim 11, wherein the location determiner, when the solution of the second equation is real values and the solution of the third equation is imaginary values or when the solution of the second equation is imaginary values and the solution of the third equation is real values, determines the solution of the second equation closest to intersections as the location of the terminal using the intersections of the second equation and the third equation.

14. The apparatus of claim 8, wherein the location determiner, when the solutions of the first equation and the second equation are imaginary values, determines the location of the terminal based on a relation between intersections of the first equation and the second equation and the third equation acquired using the Time Difference Of Arrivals according to the third reference signals.

15. A method for estimating a location of a terminal to support a location based service in a mobile communication system, the method comprising:
receiving first reference signals from three base stations;
calculating the Time Difference Of Arrivals (TDOAs) between a specific one of the three base stations and the other base stations;
solving a first equation using the Time Difference Of Arrivals based on the first reference signals; and
when a solution to the first equation is real or imaginary values, receiving second reference signals from the three base stations:
calculating the Time Difference Of Arrivals (TDOAs) between a specific one of the three base stations and the other base stations;
solving a second equation using the Time Difference Of Arrivals based on the second reference signals, and
when a solution of determining the location of the terminal based on the second equation is real or imaginary values, determining the location of the terminal based on a relation between the first equation and the second equation.

16. The method of claim 15, wherein determining the location of the terminal based on the relation between the first equation and the second equation comprises:
when the solutions of the first equation and the second equation are real values, selecting one of the solutions having a shortest distances between the solutions as the location of the terminal.

17. The method of claim 15, wherein determining the location of the terminal based on the relation between the first equation and the second equation comprises:
determining a solution of the first equation closest to intersections as the location of the terminal using the intersections of the first equation and the second equation when the solution of the first equation is real values and the solution of the second equation is imaginary values or when the solution of the first equation is imaginary values and the solution of the second equation is real values.

18. The method of claim 17, further comprising:
when there are no intersections, receiving third reference signals from the three base stations, calculating the Time Difference Of Arrivals between a specific one of the three base stations and the other base stations, and solving a third equation using the Time Difference Of Arrivals based on the third reference signals; and
when a solution of determining the location of the terminal based on the third equation is real or imaginary values, determining the location of the terminal based on a relation between the second equation and the third equation.

19. The method of claim 18, wherein determining the location of the terminal based on the relation between the second equation and the third equation comprises:
when solutions of the second equation and the third equation are real values, selecting one of solutions having a shortest distance between the solutions as the location of the terminal.

20. The method of claim 18, wherein determining the location of the terminal based on the relation between the second equation and the third equation comprises:
when the solution of the second equation is real values and the solution of the third equation is imaginary values or when the solution of the second equation is imaginary values and the solution of the third equation is real values, determining the solution of the second equation closest to intersections as the location of the terminal using the intersections of the second equation and the third equation.

21. The method of claim 15, wherein determining the location of the terminal based on the relation between the first equation and the second equation comprises:
when the solutions of the first equation and the second equation are imaginary values, determining the location of the terminal based on a relation between intersections of the first equation and the second equation and the third equation acquired using the Time Difference Of Arrivals according to the third reference signals.
